(19) United States
(12) Patent Application Publication
(10) Pub. No.: US 2023/0386016 A1
(43) Pub. Date: Nov. 30, 2023

(54) METHOD FOR INSPECTING PRODUCT DEFECTS, ELECTRONIC DEVICE, AND STORAGE MEDIUM

(71) Applicant: HON HAI PRECISION INDUSTRY CO., LTD., New Taipei (TW)

(72) Inventor: YIN-CHUNG LEUNG, New Taipei (TW)

(21) Appl. No.: 17/990,571

(22) Filed: Nov. 18, 2022

(30) Foreign Application Priority Data
May 31, 2022 (CN) 202210616191.9

(51) Int. Cl. G06T 7/00

(52) U.S. Cl. CPC G06T 7/001; G06T 2207/30108

(57) ABSTRACT

A method for inspecting product defects implemented in an electronic device includes determining a category of a product, and obtaining golden sample images of the product; selecting at least one inspection tool by a preset application according to the category of the product; creating labeling information of the golden sample image of the product according to the selected inspection tools; and obtaining at least one image of a product to be inspected, and inspecting the at least one image of the product to be inspected according to the labeling information of the golden sample images of the product.

### FIELD

The subject matter herein generally relates to product defect inspection, and particularly to an electronic device, a method for inspecting product defects, and a storage medium.

### BACKGROUND

In order to improve the quality of industrial products, quality control with defects detections is applied on the production line. Most of the existing defects detection solutions offer a native application, connected with cameras. Users are allowed to configure a variety of inspection tools in the application, which can then be applied on the production line for defects detections, such as surface defects, packaging pattern defects of industrial products, etc.

However, the development cost of native applications is too high. Development and maintenance are specialized for different operation systems. Clients often have to purchase additional operation system in order to use a specific version of the native application. Moreover, existing solutions provide defect labeling on the product image. Such overlays on the captured industrial products increases visual complexity and inconvenience, such as covering the background and inconspicuous annotation lines. In addition, existing native applications are often bundled with specified defect inspection tools. In fact, different production lines require different inspection capabilities. This varies widely according to the industry and production steps, so an all-round but single inspection application covers too much non-necessary functionalities after production line deployment.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a flowchart of an embodiment of a method for inspecting product defects according to the present disclosure.

FIG. 2 illustrates a block diagram of an embodiment of an application according to the present disclosure.

FIG. 3A illustrates a schematic view of an embodiment of an image of a product without any labeled outline according to the present disclosure.

FIG. 3B illustrates a schematic view of an embodiment of an image of a product with a labeled outline according to the present disclosure.

FIG. 4 illustrates a schematic view of an embodiment of a first stacked manner according to the present disclosure.

FIG. 5 illustrates a schematic view of an embodiment of a highlighted display mode according to the present disclosure.

FIG. 6 illustrates a schematic view of an embodiment of a hidden display mode according to the present disclosure.

FIG. 7 illustrates a schematic view of an embodiment of a zoom display mode according to the present disclosure.

FIG. 8 illustrates a schematic view of an embodiment of a second stacked manner according to the present disclosure.

FIG. 9 is a block diagram of an embodiment of an electronic device according to the present disclosure.

### DETAILED DESCRIPTION

Multiple embodiments are described in the present disclosure, but the description is exemplary rather than limiting, and there may be more embodiments and implementation solutions within the scope of the embodiments described in the present disclosure. Although many possible combinations of features are shown in the drawings and discussed in the detailed description, many other combinations of the disclosed features are also possible. Unless specifically limited, any feature or element of any embodiment may be used in combination with or in place of any other feature or element of any other embodiment.

When describing representative embodiments, the specification may present methods and/or processes as a specific sequence of steps. However, to the extent that the method or process does not depend on the specific order of steps described in the present disclosure, the method or process should not be limited to the specific order of steps described. As understood by those of ordinary skills in the art, other orders of steps are also possible. Therefore, the specific order of steps set forth in the specification should not be interpreted as limitation to the claims. In addition, the claims for the method and/or process should not be limited to the steps performed in the order as written, and those of skill in the art may readily understand that other orders may vary and still remain within the essence and scope of the embodiments of the present disclosure.

Unless otherwise defined, technical terms or scientific terms used in the embodiments shall have common meanings as construed by those of ordinary skills in the art to which the present disclosure pertains. The words “first”, “second” and the like used in the embodiments of the present disclosure do not represent any order, quantity, or importance, but are merely used to distinguish between different components. The terms “include”, “contain” or the like mean that elements or articles appearing before such terms cover elements or articles listed after the terms and their equivalents without excluding other elements or articles. The terms “connect”, “link” or the like are not limited to physical or mechanical connection, but may include electrical connections, whether direct or indirect.

A method for inspecting product defects is applied in an electronic device (e.g., an electronic device 1 shown in FIG. 9). The electronic device 1 may be a personal computer, a server, etc., the server may be a single server, a server cluster, or the like.

In one embodiment, the electronic device 1 can be within a wired network environment or in a wireless network environment. The wireless network can be radio, WI-FI, or cellular network. The cellular network can be a 4G network or a 5G network.

In one embodiment, the electronic device 1 may include at least one network device and/or at least one user device. The network device includes, but is not limited to, a single network server, a server group including a number of network servers, or cloud computing including a large number of hosts or web servers based on cloud computing.

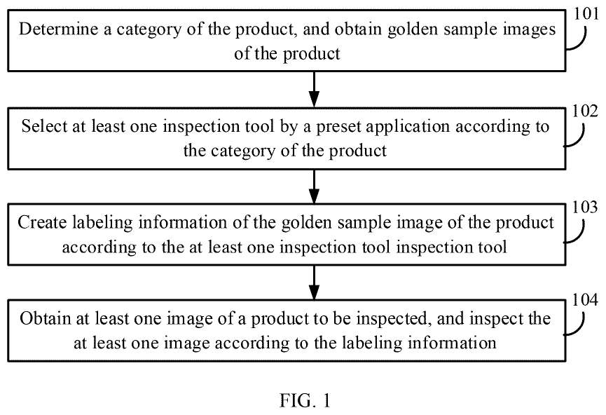

FIG. 1 illustrates a flowchart of an embodiment of a method for inspecting product defects. The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, determining a category of the product, and obtaining golden sample images of the product, the golden sample images of the product are the images of a non-defective product.

In one embodiment, the category of the product includes, but are not limited to, IC chips, wafer shipping boxes, plastic products, and the like.

In one embodiment, the golden sample images are obtained in response to input operations from a user. In other embodiments, the golden sample images may also be pre-stored in a database. For example, the image of the non-defective product may be an image of a plastic product which has no scratches.

At block 102, selecting at least one inspection tool by a preset application according to the category of the product.

In one embodiment, the preset application is developed using a preset programming language and web development technology. In one embodiment, the application developed by using the web development technology can reduce the cost, and it is easier to introduce different kinds of inspection tools. The preset programming language includes JavaScript, and the web development technology includes Hyper Text Markup Language (HTML), and Cascading Style Sheets (CSS).

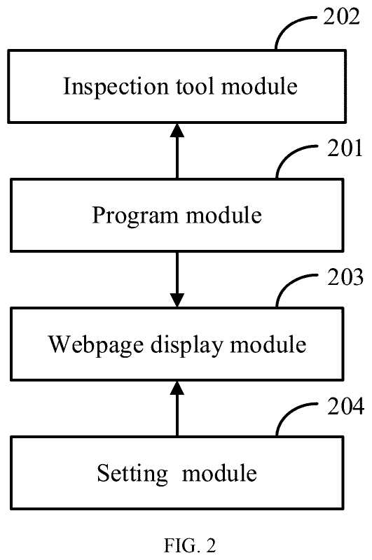

Referring to FIG. 2, the application includes a program module 201, an inspection tool module 202, a webpage display module 203, and a setting module 204. The program module 201 designs the interfaces and functions of the application, and designs the overall visual structure and operational logic of the application.

The inspection tool module 202 stores at least one inspection tool. The program module 201 can be used to invoke one of the inspection tools stored in the inspection tool module 202. In one embodiment, each inspection tool has an identification number, and the program module 201 can directly invoke the inspection tool according to the identification number. For example, when the program module 201 performs an inspection on the patterns of a product package by using a pattern inspection tool, which may have an identification number as “Pattern1”, the program module 201 can invoke the pattern inspection tool by finding the corresponding codes matching the identification number of the pattern inspection tool.

The webpage display module 203 displays the content developed in the program module 201 on a webpage. In one embodiment, the webpage display module 203 loads and displays the content by means of a browser or an application.

The setting module 204 sets the application. In one embodiment, the setting of the application includes presetting the display mode of the defect detection result. The display modes include a highlighted display mode, a hidden display mode, and a zoom display mode.

In one embodiment, selecting at least one inspection tool by a preset application according to the category of the product includes: selecting at least one inspection tool provided by the inspection tool module 202 according to the category of the product. For example, if the category of the product is an IC Chip, the inspection tools to be selected are IC defects related inspection tools.

Since different inspection tools can be stored in the application, specific inspection tools can be determined according to the category of the product to be inspected, and the inspection tools can be flexibly deployed on different products.

At block 103, creating labeling information of the golden sample image of the product according to the selected inspection tools.

In one embodiment, the labeling information includes a labeled position and a labeling method. The labeled position is the inspection area of the golden sample image of the product.

In one embodiment, the method further includes: labeling the golden sample image of the product according to the labeling information by using the selected at least one inspection tool.

In one embodiment, labeling the golden sample image of the product includes automatically labeling the golden sample image of the product by the electronic device, and/or manually labeling the golden sample image of the product by the user.

In one embodiment, the labeled position of the golden sample image of the product is determined according to the inspection tool, and the golden sample image of the product is labeled according to the inspection area of the golden sample image of the product. For example, if the inspection tool is a text printing inspection tool, the position of the printed text of the product in the golden sample image is required to be labeled. If the inspection tool is a pattern inspection tool, the position of the pattern of the product in the golden sample image is required to be labeled.

In one embodiment, the labeling method of the golden sample image of product is determined according to the inspection tool, and the golden sample image of product is labeled according to the labeling method. In one embodiment, the labeling method includes, but is not limited to, labeling the golden sample image of the product by means of polygon shapes, characters, lines, and the like.

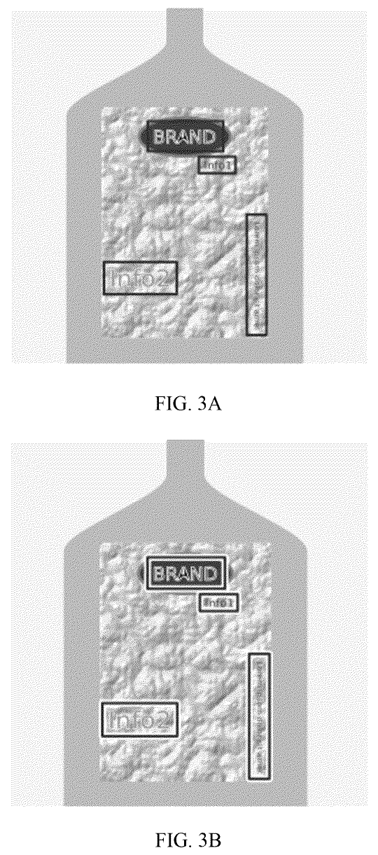

When the image is complex, a label with white outline can make the label clearer and improve readability. For example, referring to FIG. 3A, the labels are not surrounded by a white outline, so the labels are not clear and are hard to see. Referring to FIG. 3B, the labels are displayed together with a white outline, so the labels are clear and readable.

In one embodiment, the method further includes: detecting whether the labeling of the golden sample image of the product matches the labeling criteria predefined by the corresponding inspection tools; if the labeling of the golden sample image of the product does not match the label criteria predefined by the selected inspection tools, it is determined that the labeling of the golden sample image of the product is incorrect, thus outputting a warning message to prompt the user to re-label the golden sample image of the product.

In one embodiment, when the inspection tools are different, the preset labeled position or labeling method of the inspection tool are also different. Detecting whether the labeling of the golden sample image of the product matches the labeling criteria predefined by the corresponding inspection tools includes: detecting whether the labeled position of the golden sample image matches the preset labeled position limit of the inspection tool, and detecting whether the labeled count of the golden sample image matches the preset labeling count range of the inspection tool.

In one embodiment, if the labeled position in the golden sample image of the product does not match the preset labeled position limit of the selected inspection tool, it is determined that the labeled position of the golden sample image of the product is incorrect, thus outputting the warning message to prompt the user to re-label the golden sample image of the product; or if the labeled count in the golden sample image of the product does not match the preset labeling count range of the selected inspection tool, it is determined that the labeled count of the golden sample image of the product is incorrect, thus outputting the warning message to prompt the user to re-label the golden sample image of the product; or if the labeled position in the golden sample image of the product does not match the labeled position limit of the selected inspection tool, and the labeled count in the golden sample image of the product does not match the preset labeling count range of the selected inspection tool, it is determined that the labeled position and labeling count of the golden sample image of the product is incorrect, thus outputting the warning message to prompt the user to re-label the golden sample image of the product.

In one embodiment, the warning message may be displayed by the electronic device and a prompt sound may be output by the electronic device, such as a preset voice or a buzzer sound.

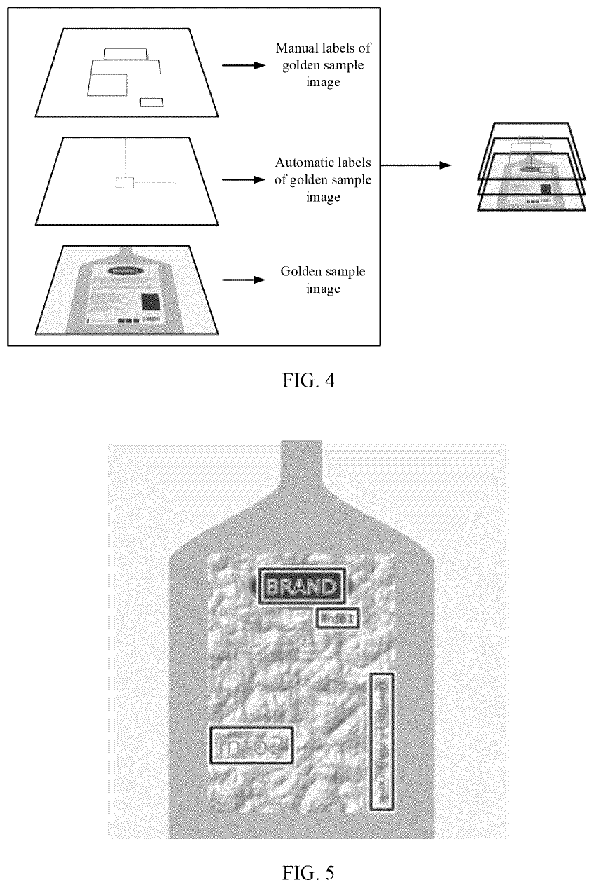

In one embodiment, the method further includes: displaying the golden sample image of the product, the automatic labels of the golden sample image of the product by the electronic device, and the manual labels of the golden sample image of the product by the user with matching results on a display device. For example, referring to in FIG. 4, the golden sample image of the product is arranged at the bottom, the automatic labels of the golden sample image is arranged at the middle, and the manual labels of the golden sample image of the product is arranged at the top. It should be noted that the figure is only an example, and the golden sample image of the product may be in the middle, or may be at the top, which is not specifically limited.

At block 104, obtaining images of a product to be inspected, and inspecting the image of the product for defects according to the labeling information of the golden sample image of the product.

In one embodiment, the images of the product to be inspected are the images of products that are required to be checked for defects.

In one embodiment, obtaining images of the product to be inspected includes: obtaining the images of the product to be inspected by controlling a camera device to capture the images of the product from the same capturing position and capturing angle.

In one embodiment, inspecting the image of the product for defects according to the labeling information of the golden sample image of the product includes: determining inspection information of the images of product to be inspected according to the labeling information of the golden sample image; inspecting the image of the product to be inspected by the at least one inspection tool according to the inspection information, and obtaining inspection results.

In one embodiment, the inspection information includes a labeled position in the image of the product to be inspected. The labeled position in the image of the product to be inspected is the inspection position in the image of the product to be inspected.

In one embodiment, determining inspection information of the images of product to be inspected according to the labeling information of the golden sample image includes: determining the inspection position in the product to be inspected according to the labeled position in the golden sample image of the product.

In one embodiment, the labeled position in the golden sample image of the product is the same as the inspection position in the image of the product to be inspected.

In one embodiment, inspecting the image of the product to be inspected by the at least one inspection tool according to the inspection information, and obtaining inspection results includes: inspecting the labeled position in the image of the product to be inspected over the labeled position in the golden sample image by using the selected inspection tool. For example, when the selected inspection tool is the pattern inspection tool, and the user labels the pattern position in the golden sample image of the product, so the inspection result can be obtained by inspecting the image of the product over the labeled position in the golden sample image, thus displaying the inspection result on the display device. It should be noted that the capturing angle and capturing position of the camera device when capturing the image of the product and the image of the golden sample are the same.

In one embodiment, the method further includes: providing a display mode option, and determining a display mode corresponding to the display mode option in response to an input operation from the user on the display mode option. In one embodiment, the display modes include a highlighted display mode, a hidden display mode, and a zoom display mode.

In one embodiment, multiple display mode options and graphic illustrations and/or text descriptions of the corresponding display mode options may be provided for the user to select a display mode for reference.

In one embodiment, if the user selects the highlighted display mode as the display mode of the inspection result, the inspection result will be displayed on the display device in the highlighted display mode. Referring to FIG. 5, the inspection result in the highlight display mode is illustrated, with a white outline as the highlighted label.

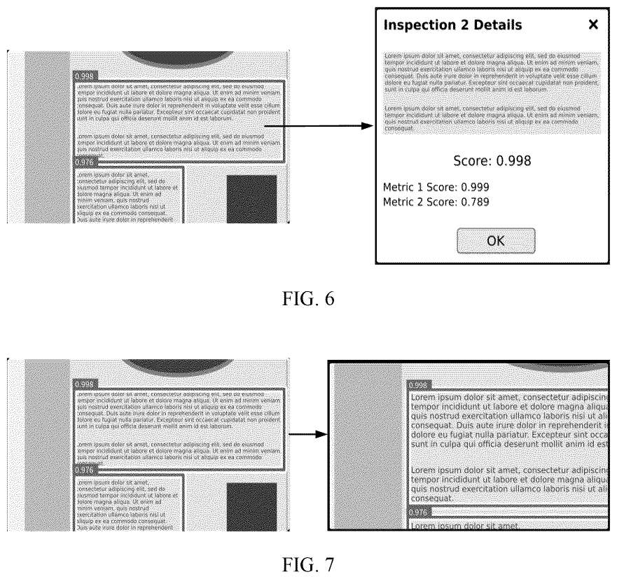

In one embodiment, if the user selects the hidden display mode as the display mode of the inspection result, the inspection result will be displayed on the display device in the hidden display mode. Referring to FIG. 6, the inspection details is hidden in the label box. When the result label box is clicked, the detailed description of the inspection result will be displayed, and if the label box is clicked again, the detailed description of the inspection result will be hidden. In one embodiment, the detailed inspection labels can be displayed on a blurred background, a solid color background, or a semi-transparent background.

In one embodiment, if the user selects the zoom display mode as the display mode of the inspection result, the inspection result will be displayed on the display device in the zoom display mode. Referring to FIG. 7, the inspection result in a zoom display mode is illustrated, and the inspection result is zoomed in.

In one embodiment, the labels of the inspection results can be zoomed in or zoomed out, the font size and the width of the outline can be adjusted, and can also be maintained as the size of the display device, so as to improve the readability of the inspection results. In one embodiment, the detailed inspection detection result labels are displayed on a blurred background, a solid color background, or a semi-transparent background.

It should be noted that the user can select at least one display mode, and multiple display modes can be used in combination with each other.

In one embodiment, the method further includes: displaying the inspection result on the display device in a second stacking manner. In one embodiment, the second stacking manner includes stacking and displaying the inspection results of different inspection tools.

For example, if there are three kinds of inspection tools, namely, the barcode inspection tool, text inspection tool, and pattern inspection tool are used to inspect the product for defects, the defect inspection results of the three defect detection tools are displayed in a stacked manner.

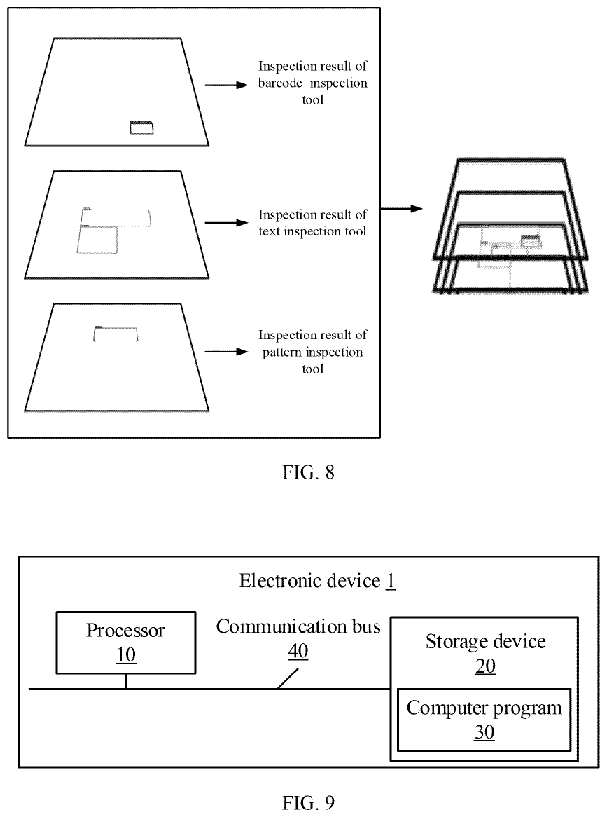

Referring to FIG. 8, the inspection result of the pattern defect detection tool is arranged at the bottom, the inspection result of the text defect detection tool is arranged at the middle, and the inspection result of the barcode inspection tool is arranged at the top. It should be noted that the figure is only an example, and the inspection result of the pattern inspection tool may be in the middle or the top, which is not specifically limited.

It should be noted that the image can be also displayed in a stacked manner with the inspection result.

FIG. 9 illustrates the electronic device 1 in one embodiment. The electronic device 1 includes, but is not limited to, a processor 10, a storage device 20, a computer program 30, and a communication bus 40. The storage device 20 communicates with the processor 10 through the communication bus 40. FIG. 9 illustrates only one example of the electronic device 1. Other examples can include more or fewer components than as illustrated or have a different configuration of the various components in other embodiments.

The processor 10 can be a central processing unit (CPU), a microprocessor, or other data processor chip that performs functions in the electronic device 1.

In one embodiment, the storage device 20 can include various types of non-transitory computer-readable storage mediums. For example, the storage device 20 can be an internal storage system, such as a flash memory, a random access memory (RAM) for the temporary storage of information, and/or a read-only memory (ROM) for permanent storage of information. The storage device 20 can also be an external storage system, such as a hard disk, a storage card, or a data storage medium.

The storage device 20 stores instructions, the processor 10 executes the computer program 30 stored in the storage device 20 for implementing the method for inspecting product defects provided in the embodiments of the present disclosure. The computer program 30 may be a defect inspection program and include instructions.

The processor 10 is configured to:
execute the computer program 30 and render the application interface to the display screen, such as displaying golden sample images, stacking labeling information, displaying application layout, and the like;
handle logical processes by the browser or native application which executes the computer program 30, to provide user interactions, such as selecting inspection tools, labeling golden sample images, applying inspection settings over the production line, and the like;
obtain images of the golden sample product, and perform golden sample checking specified by the computer program 30, such as auto-labeling golden sample images, validating label positions and count, and the like; and
obtain images of the product to be inspected, and inspect the image of the product to be checked for defects according to the labeling information of the golden sample image of the product.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A method for inspecting product defects implemented in an electronic device comprising:
determining a category of a product, and obtaining golden sample images of the product;
selecting at least one inspection tool by a preset application according to the category of the product;
creating labeling information of the golden sample images of the product according to the at least one inspection tool; and
obtaining at least one image of a product to be inspected, and inspecting the at least one image of the product to be inspected according to the labeling information of the golden sample images of the product.

2. The method according to claim 1, wherein inspecting the at least one image of the product to be inspected according to the labeling information of the golden sample images of the product comprises:
determining inspection information of the at least one image of product to be inspected according to the labeling information of the golden sample images; and
inspecting the at least one image of the product to be inspected by the at least one inspection tool according to the inspection information, and obtaining inspection results.

3. The method according to claim 1, further comprising:
labeling the golden sample image of the product according to the labeling information of the at least one inspection tool;
detecting whether each label of the golden sample image of the product matches a predefined labeling criteria of the at least one inspection tool; and
in response that each label of the golden sample image of the product does not match the predefined labeling criteria of the at least one inspection tool, determining that the label of the golden sample image of the product is incorrect.

4. The method according to claim 3, further comprising:
outputting a warning message and prompting a user to re-label the golden sample image of the product; and
displaying the golden sample image of the product, automatic labels of the golden sample image of the product by the electronic device, and manual labels of the golden sample image of the product by a user with matching results on a display device in a first stacked manner.

5. The method according to claim 1, further comprising:
presetting a display mode of the inspection results by the preset application.

6. The method according to claim 5, wherein setting a display mode of the inspection results by the preset application comprises:
providing a display mode option; and
determining a display mode corresponding to a display mode option in response to an input operation from a user on the display mode option, display modes comprising a highlighted display mode, a hidden display mode, and a zoom display mode.

7. The method according to claim 5, further comprising:
displaying the inspection results on a display device in a preset display mode.

8. The method according to claim 7, further comprising:
displaying the inspection results on the display device in a second stacking manner, the second stacking manner comprising stacking and displaying the inspection results of different inspection tools.

9. An electronic device comprising:
at least one processor; and
a storage device coupled to the at least one processor and storing instructions for execution by the at least one processor to cause the at least one processor to:
determine a category of a product, and obtain golden sample images of the product;
select at least one inspection tool by a preset application according to the category of the product;
create labeling information of the golden sample images of the product according to the at least one inspection tool; and
obtain at least one image of a product to be checked, and inspect the at least one image of the product to be checked for defects according to the labeling information of the golden sample images of the product.

10. The electronic device according to claim 9, wherein the at least one processor is further caused to:
determine inspection information of the at least one image of product to be inspected according to the labeling information of the golden sample images; and
inspect the at least one image of the product to be inspected by the at least one inspection tool according to the inspection information, and obtaining inspection results.

11. The electronic device according to claim 9, wherein the at least one processor is further caused to:
label the golden sample image of the product according to the labeling information of the at least one inspection tools;
detect whether each label of the golden sample image of the product matches a predefined label criteria of the at least one inspection tool; and
in response that each label of the golden sample image of the product does not match the predefined label criteria of the at least one inspection tool, determine that the label of the golden sample image of the product is incorrect.

12. The electronic device according to claim 11, wherein the at least one processor is further caused to:
output a warning message and prompting a user to relabel the golden sample image of the product; and
display the golden sample image of the product, automatic labels of the golden sample image of the product by the electronic device, and manual labels of the golden sample image of the product by a user with matching results on a display device in a first stacked manner.

13. The electronic device according to claim 9, wherein the at least one processor is further caused to:
presetting a display mode of the inspection results by the preset application.

14. The electronic device according to claim 13, wherein the at least one processor is further caused to:
provide a display mode option; and
determine a display mode corresponding to a display mode option in response to an input operation from a user on the display mode option, wherein display modes comprise a highlighted display mode, a hidden display mode, and a zoom display mode.

15. The electronic device according to claim 13, wherein the at least one processor is further caused to:
display the inspection results on a display device in a preset display mode.

16. The electronic device according to claim 15, wherein the at least one processor is further caused to:
display the inspection results on the display device in a second stacking manner, wherein the second stacking manner comprises stacking and displaying the inspection results of different inspection tools.

17. A computer-readable storage medium having instructions stored thereon, when the instructions are executed by a processor of an electronic device, the processor is configured to perform a method for inspecting product defects, wherein the method comprises:
determining a category of a product, and obtaining golden sample images of the product;
selecting at least one inspection tool by a preset application according to the category of the product;
creating labeling information of the golden sample images of the product according to the at least one inspection tool; and
obtaining at least one image of a product to be inspected, and inspecting the at least one image of the product to be inspected according to the labeling information of the golden sample images of the product.

18. The storage medium according to claim 17, wherein inspecting the at least one image of the product to be inspected according to the labeling information of the golden sample images of the product comprises:
determining inspection information of the at least one image of product to be inspected according to the labeling information of the golden sample images; and
inspecting the at least one image of the product to be inspected by the at least one inspection tool according to the inspection information, and obtaining inspection results.

19. The storage medium according to claim 17, wherein the method further comprises:
labeling the golden sample image of the product according to the labeling information of the at least one inspection tool;
detecting whether each label of the golden sample image of the product matches a predefined labeling criteria of the at least one inspection tool; and
in response that each label of the golden sample image of the product does not match the predefined labeling criteria of the at least one inspection tool, determining that the label of the golden sample image of the product is incorrect.

20. The storage medium according to claim 19, wherein the method further comprises:
outputting a warning message and prompting a user to relabel the golden sample image of the product; and
displaying the golden sample image of the product, automatic labels of the golden sample image of the product by the electronic device, and manual labels of the golden sample image of the product by a user with matching results on a display device in a first stacked manner.
